(19) United States
(12) Patent Application Publication
(10) Pub. No.: US 2021/0295030 A1
(43) Pub. Date: Sep. 23, 2021

(54) SCANNING DEVICES WITH ZONAL OCR USER INTERFACES

(71) Applicant: Hewlett-Packard Development Company, L.P., Spring, TX (US)

(72) Inventors: Peter G. Hwang, Vancouver, WA (US); Timothy P. Blair, Boise, ID (US); Jordi Padros Dominguez, Boise, ID (US)

(73) Assignee: Hewlett-Packard Development Company, L.P., Spring, TX (US)

(21) Appl. No.: 17/258,358

(22) PCT Filed: Dec. 12, 2018
(86) PCT No.: PCT/US2018/065182

§ 371 Date: Jan. 6, 2021

(51) Int. Cl. G06K 9/00; G06K 9/20; G06F 3/0488

(52) U.S. Cl. CPC G06K 9/00456; G06K 9/2063; G06K 2209/01; G06F 3/0488; G06K 9/2081

(57) ABSTRACT

In example implementations, an apparatus is provided. The apparatus includes an imaging device, a display, a zonal optical character recognition (OCR) device, and a processor. The imaging device is to scan a document to generate a scanned document. The display is to provide a graphical user interface (GUI) to display the scanned document and an electronic form. The zonal OCR device is to scan a selected area of the scanned document. The processor is communicatively coupled to the imaging device, the display, and the zonal OCR device. The processor is to receive a selection of the selected area on the display, to receive a selection of a field on the electronic form, to obtain data from the selected area of the scanned document that is scanned, and to enter the data in the field of the electronic form that is selected.

### BACKGROUND

In industry, paper documents may be collected. The paper documents may include data that can be entered into a database or spreadsheet to be electronically tracked. For example, some departments in enterprises may transpose the data from the paper documents into various different fields of a database.

In some examples, the paper documents can be scanned to generate electronic versions of the document. The electronic versions of the document can then be accessed from a computer at an employee's workstation. The employee can then manually enter data from the electronic document into various fields of a database.

Yet in other examples, the data may be entered manually from a paper copy at a computing device. The user may then go to a multi-function printer to scan the document and attach the scan to the bill line item that was created at the computing device.

### BRIEF DESCRIPTION OF THE DRAWINGS

FIG. 1 is a block diagram of an example apparatus of the present disclosure;

FIG. 2 is a block diagram of the apparatus in an example network of the present disclosure;

FIG. 3 is a block diagram of an example user interface of the apparatus to train the apparatus for a particular workflow of the present disclosure;

FIG. 4 is a block diagram of an example user interface of the apparatus that automatically generates a completed form with data that is obtained from optical character recognition of a scanned document based on an identified work flow of the present disclosure;

FIG. 5 is a flow chart of an example method for entering data via zonal OCR selections of a scanned document at a scanning device of the present disclosure; and

FIG. 6 is a block diagram of an example non-transitory computer readable storage medium storing instructions executed by a processor to enter data via zonal OCR selections of a scanned document at a scanning device.

### DETAILED DESCRIPTION

Examples described herein provide an apparatus and method to enter data via zonal OCR selections of a scanned document at a scanning device. As discussed above, data in some paper forms may be collected and entered into electronic databases or documents to electronically track the data. In some examples, the data may be manually entered by an employee via manually retyping via a computer keyboard. For example, the employee may look at the paper document or scan the document and look at the electronic scanned copy of the paper document. In either case, the user may have to go to the scanning device and then return to his or her workstation to transfer the data from the scanned document into an electronic form by manually retyping it. The process may be inefficient, tedious, and potentially lead to human error in data entry.

Examples herein provide an apparatus and method that allows an employee to enter data via zonal OCR selections of a scanned document at the scanning device. In other words, a user may make a single trip to a scanning device to perform zonal OCR selections and populate fields of an electronic form with data from the zonal OCR selections, thereby avoiding the need to manually retype.

In one example, the scanning device may learn patterns from everyday use from different users. The scanning device may calculate a confidence score for predictions in populating fields of an electronic form as users populate fields via zonal OCR selections of scanned documents. When the confidence score exceeds a threshold, the scanning device may automatically generate electronic documents from the scanned documents via zonal OCR selections for a particular workflow. Notably, no structured training using training documents is performed. Rather, the scanning device may “crowdsource” data from everyday use and user selections made at the scanning device to learn patterns that can be used to automatically generate electronic forms.

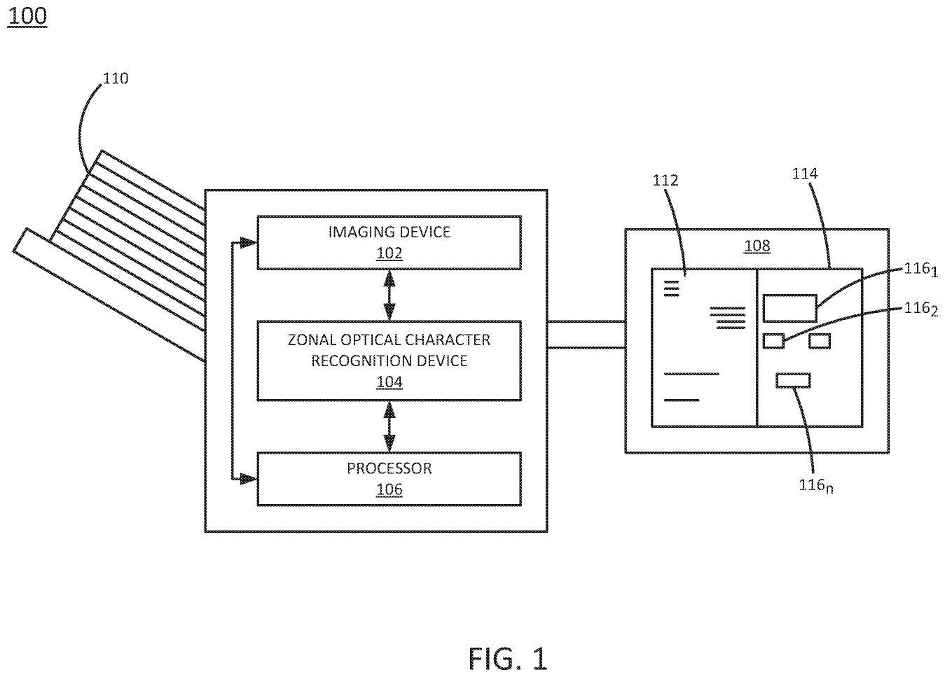

FIG. 1 illustrates an example apparatus 100 to provide a user interface that allows zonal OCR of scanned documents to populate fields of an electronic form of the present disclosure. In one example, the apparatus 100 may be a stand-alone scanner, a scanning device, a multi-function device (MFD), and the like.

In one example, the apparatus 100 may include an imaging device 102, a zonal optical character recognition (OCR) device 104, a display 108, and a processor 106. The processor 106 may be communicatively coupled to the imaging device 102, the zonal OCR device 104, and the display 108 to control the operation of the imaging device 102, the zonal OCR device 104, and the display 108.

In one example, the display 108 may be a relatively large display and may be a touch screen interface. The display 108 may be part of the apparatus 100 or may be detached from the apparatus 100. For example, the display 108 may be part of a mobile computing device or a mobile phone that may be in communication with the apparatus 100.

In one example, the display 108 may provide a graphical user interface (GUI) that allows for zonal OCR at the apparatus 100. In addition, the display 108 may allow the zonal OCR to obtain data from a scanned document 112 to populate fields 116₁ to 116ₙ (hereinafter also referred to individually as a field 116 or collectively as fields 116) of an electronic form 114.

As a result, a user may complete a workflow at the apparatus 100. A workflow may identify a particular electronic form 114 that should be generated based on the scanned document 112. Workflows may be general to specify a department (e.g., accounting, accounts receivables, shipping, payroll, and the like). Forms associated with the department may then be shown as the electronic form 114 to be completed in the display 108. In one example, the workflows may specify a particular form to be completed such as, an invoice, a receipt, a shipping form, a payroll form, and the like.

In previous processes to complete a workflow, a user may go to a scanner to scan a document, and then go back to his or her desk to complete the OCR and complete an electronic form. Previous scanners did not provide a user interface to allow for zonal OCR and electronic form completion at the scanner. In contrast, the apparatus 100 may provide the display 108 and functionality to complete the workflow in a single stop at the apparatus 100.

For example, a user may feed a document 110 through the apparatus 100. The imaging device 102 may scan the document 110 to generate the scanned document 112 shown in the display 108. In one example, the GUI may show the electronic form 114 selected by the user for a workflow. In one example, the user may input the workflow through menu options in the display 108 and the electronic form 114 may be shown based on the workflow that is selected. In another example, the user may select the electronic form 114 from a menu of available electronic forms shown in the GUI of the display 108. In one example, the processor 106 may select the form automatically, based on learned pattern recognition from the crowdsourced zonal OCR data entry, as discussed in further details below.

The user may select certain zones or regions of a scanned document 112 to perform zonal OCR in the selected zone. The processor 106 may receive the selected area or areas in the scanned document 112. The processor 106 may cause the zonal OCR device 104 to OCR the selected area to obtain data from the selected area of the scanned document 112. The processor 106 may then populate a field 116. The field 116 may be selected by a user via the GUI in the display 108 or may be automatically selected by the processor 106 based on the data that is obtained from the zonal OCR. The process may be repeated until the desired fields 116 are completed and the electronic form 114 is completed.

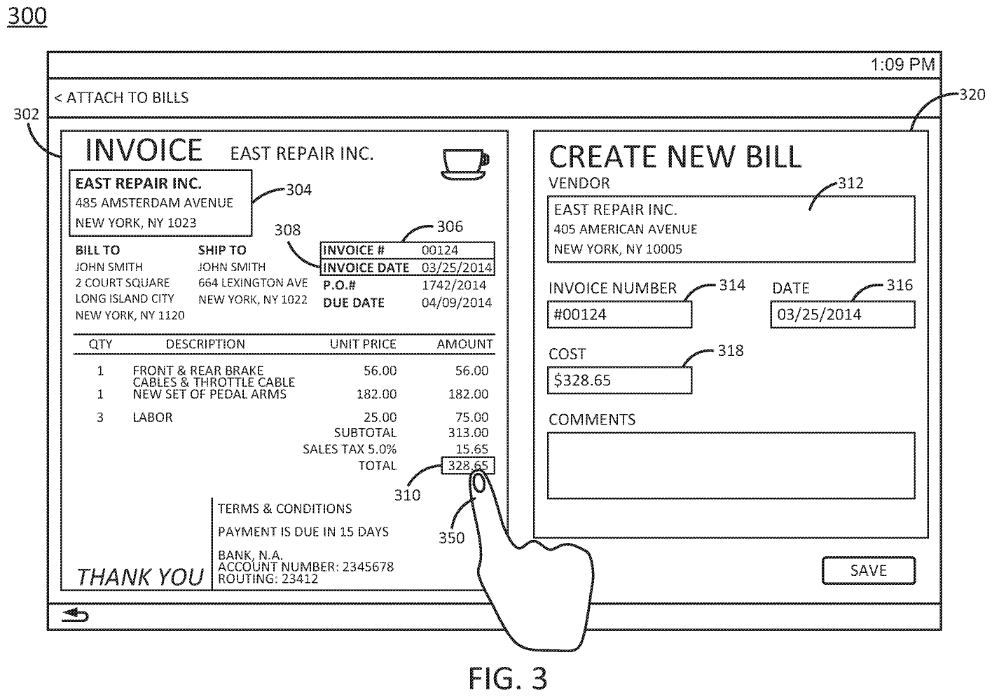

FIG. 3 illustrates an example GUI 300 that is shown by the display 108. In one example, a scanned document 302 may be shown next to an electronic form 320 that is to be completed. The user may select a field 312, 314, 316, or 318 and select areas 304, 306, 308, and 310, respectively to populate data into the fields 312, 314, 316, and 318. For example, a user 350 may touch the field 312. The user 350 may then highlight with his or her finger the area 304 to perform zonal OCR.

The description in which the selections and zonal OCR are performed are not intended to indicate any particular order. For example, the process described above could be done in reverse. For example, the selected areas 304, 306, 308, and 310 may be highlighted by a user on the scanned document 302 and the user may drag and drop the highlighted areas into selected fields 312, 314, 316, and 318. The zonal OCR may be performed on the selected areas 304, 306, 308, and 310 as the user is dragging and dropping them into the selected fields 312, 314, 316, and 318.

In one example, a selected field may have a freeform area (e.g., the comments field). Text that is obtained from zonal OCR performed on the selected areas 304, 306, 308, and 310 can be inserted between existing text at selected locations within the existing text in the freeform area.

As noted above, the processor 106 may cause the zonal OCR device 104 to scan the area 304. The pixels of the image data in the scanned document 302 may be analyzed and converted into ASCII, or other electronic font formats, that can be used to populate the field 312. The data in the fields 314, 316, and 318 can be similarly populated with zonal OCR on the selected areas 306, 308, and 310. As a result, the user 350 may complete the electronic form 320 using zonal OCR at the apparatus 100, rather than having to scan the document 110 and then go back to his or her desk and complete the electronic form on a personal computer typing with their keyboard.

In one example, the apparatus 100 may be trained from everyday use by different users who scan different documents 110, and populate different fields 116 of different electronic forms 114 from different selected areas of scanned documents 112. Each time a document 110 is scanned, the processor 106 may attempt to predict the fields 116 that are selected and the areas of the scanned document 112 that are selected.

A document classification or forms recognition device may also be included in the apparatus 100. The document classification device may learn on which areas on which types of forms to perform zonal OCR based on monitoring the everyday use by different users who scan different documents 100. The document classification device can calculate a confidence score based on the accuracy of the prediction. For example, if 10 fields and 10 areas were predicted and the processor 106 correctly predicted 9 out of 10 fields and areas, then the confidence score may be 90%. The confidence score may be calculated as a percentage or a value (e.g., between 0 and 100).

For a given workflow, the processor 106 may attempt to automatically generate a completed electronic form when the confidence score is above a high threshold (e.g., greater than 90%, 95%, 99%, and the like). When the confidence score is above the high threshold, the processor 106 may automatically complete the electronic form 114 without showing the user the scanned document 112 and the electronic form 114 in the display 108.

In one example, when the confidence score is above a low threshold, but below a high threshold, the processor 106 may automatically complete the electronic form 114, but show the completed electronic form in the display 108. For example, the completed electronic form may be shown next to the scanned document 112 in the display 108 to allow a user to verify and, where appropriate, correct the data in the fields 116 of the electronic form 114.

In one example, when the confidence score is below the low threshold, the processor 106 may allow the user to select the fields 116 and the areas for zonal OCR. The processor 106 may continue to try and learn patterns with each document 110 that is scanned until the processor 106 can successfully predict the fields 116 and the areas of a scanned document 112 that may be selected. Form completion may become automatic once a particular confidence score is reached.

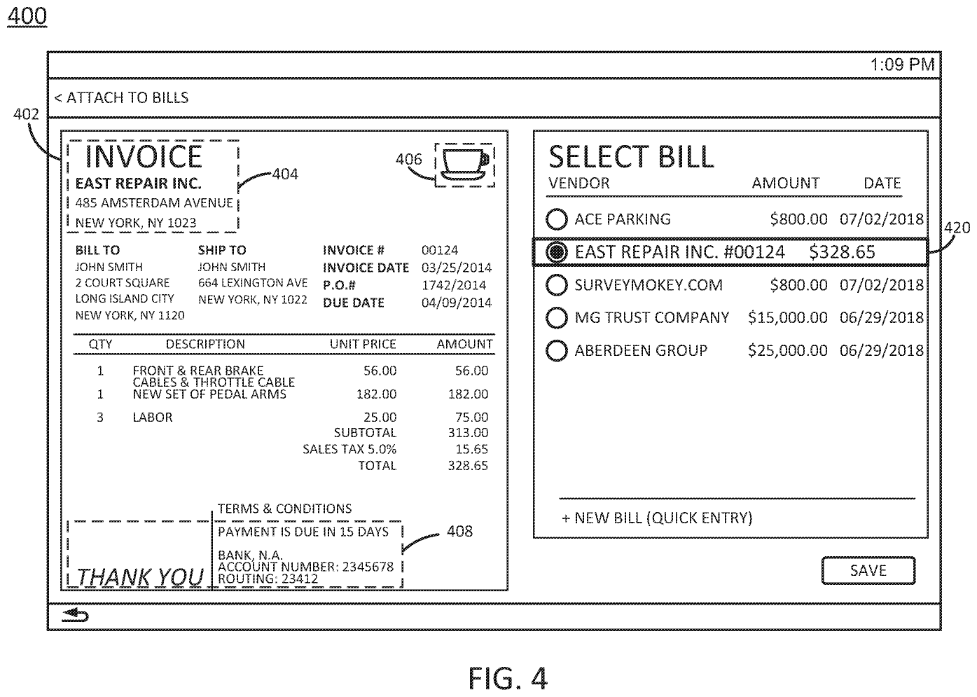

FIG. 4 illustrates an example of a GUI 400 when the apparatus 100 automatically generates a completed electronic form 420. For example the completed electronic form 420 may be saved as a file in a file directory. The file directory may be shown to allow a user to select the completed electronic form 420 to view or verify the data if the user wishes.

In one example, based on patterns that are learned from different scanned documents 402 from different users, the processor 106 may learn a format of the scanned documents 402. In one example, the GUI 400 may show the scanned document 402 that was used to generate the completed electronic form 420.

In one example, the processor 106 may analyze certain areas or locations of the scanned document 402 for recognized markers. For example, the locations 404, 406, and 408 may be analyzed by the processor 106 to detect if the scanned document 402 is for a particular company that may have a different format. For example, the processor 106 may analyze the location 404 for a particular font. For example, different companies may use unique fonts. In one example, the processor 106 may analyze the location 406 as certain companies may use a logo in the location 406. In one example, the processor 106 may analyze the location 408 as certain companies may use a unique salutation or place company information at the bottom of the scanned document 402.

Based on analysis of the locations 404, 406, and 408 the processor 106 may determine if the scanned document 402 is from a particular company that has a different format for certain documents than other companies for a given workflow. If so, the zonal OCR may be adjusted to the locations for the identified company in the scanned document 402, as described above.

In one example, the processor 106 may analyze the scanned document 402 for certain keywords and associated values. For example, certain companies may list a “total” with an associated value (e.g., $100.05) in different places within different documents 110. As a result, the processor 106 may learn to search for a keyword and associated value in the scanned document 402 and then perform the zonal OCR on the keyword and the associated value that is found.

Notably, the apparatus 100 can be trained without any standardized training documents or training session. Rather, the apparatus 100 can learn patterns to detect a format of documents 110 for a given workflow. Daily use of the apparatus 100 from different users (e.g., employees of an enterprise) may provide data to the processor 106 that can be analyzed to learn a format of the document 110, which areas are selected in the scanned document 112 for which fields 116 in the electronic form 114, and so forth.

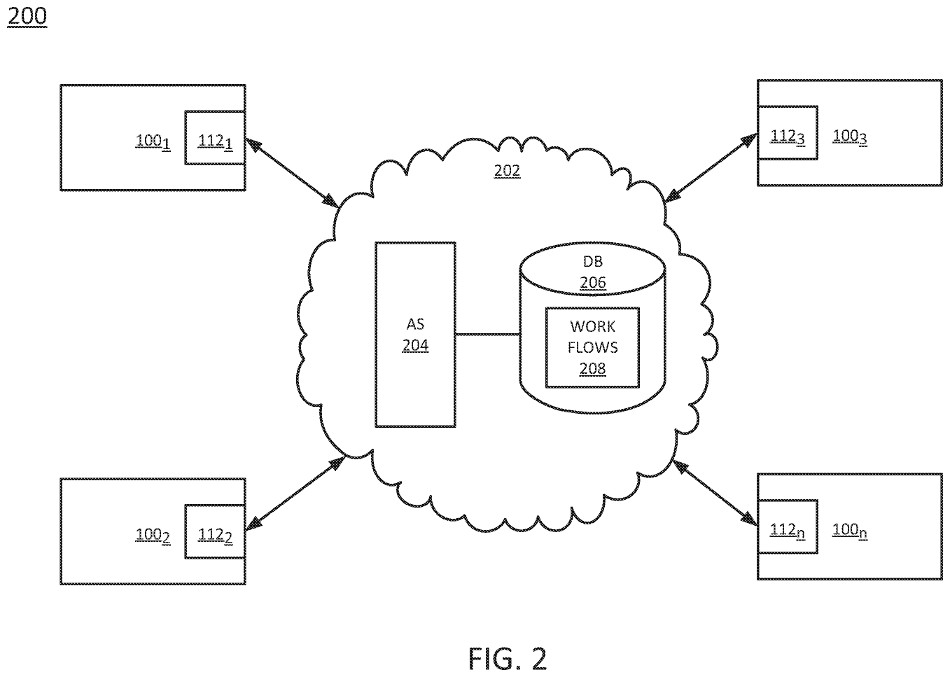

FIG. 2 illustrates an example network 200 of the present disclosure. In one example, a plurality of apparatuses 100₁ to 100ₙ may be located at different locations. The apparatuses 100₁ to 100ₙ may be located in different buildings or floors of an enterprise location, at different campuses at different geographic regions of an enterprise, and the like.

In one example, each one of the apparatuses 100₁ to 100ₙ may include a respective communication interface 112₁ to 112ₙ (hereinafter also referred to individually as a communication interface 112 or collectively as communication interfaces 112). The communication interface may be a wired or wireless communication interface. The communication interfaces 112 may allow the respective apparatus 100₁ to 100ₙ to establish a communication path to a centralized network 202 of an application server (AS) 204 and a database (DB) 206.

The centralized network 202 may be an Internet protocol (IP) network. The centralized network 202 may include additional network elements that are not shown, such as for example, routers, gateways, switches, firewalls, and the like.

In one example, the electronic forms 114 that are generated may be transmitted to the AS 204 for processing and stored in the DB 206. The data associated with the zonal OCR performed on the scanned document 112, the information in each of the fields 116 and the electronic forms 114 may be transmitted to the AS 204. In one example, the AS 204 may perform analysis on the data to learn the format of certain documents for a particular workflow.

In other words, data may be collected from daily use of the apparatuses 100 by employees or users to detect formats of certain documents, or to detect patterns for which areas are selected to perform zonal OCR to obtain data for which fields in the electronic form. The AS 204 may learn the patterns and provide the instructions to the apparatuses 100 when documents are scanned. For example, for a selected work flow, a scanned document may be transmitted to the AS 204. The AS 204 may provide the electronic form for the selected workflow and provide instructions with respect to which areas of the scanned document should be selected to perform zonal OCR for which fields of the electronic document.

In one example, workflows 208 may be stored in the DB 206. The workflows 208 may include the electronic forms 114 that should be generated for a particular workflow and may include known formats for the workflow. In one example, when a user selects a workflow at an apparatus 100₁, the apparatus 100₁ may communicate with the AS 204 via the centralized network 202.

The apparatus 100₁ may query the AS 204 whether or not the format for the selected workflow has been learned and is stored in the DB 206. If the workflow has been learned, the electronic forms and format information may be obtained from the workflows 208 and transmitted back to the apparatus 100₁. The apparatus 100₁ may load the electronic forms 114 for the selected workflow and load the format information. The format information may allow the processor 106 to know on which locations of the scanned documents 112 to have the OCR device 104 perform zonal OCR.

In some examples, the zonal OCR device 104 and/or the document classification device, discussed above, may be part of the AS 204. As a result, the zonal OCR and document classification for each scanned document at the different apparatuses 100 may be performed at a centralized location, such as the AS 204.

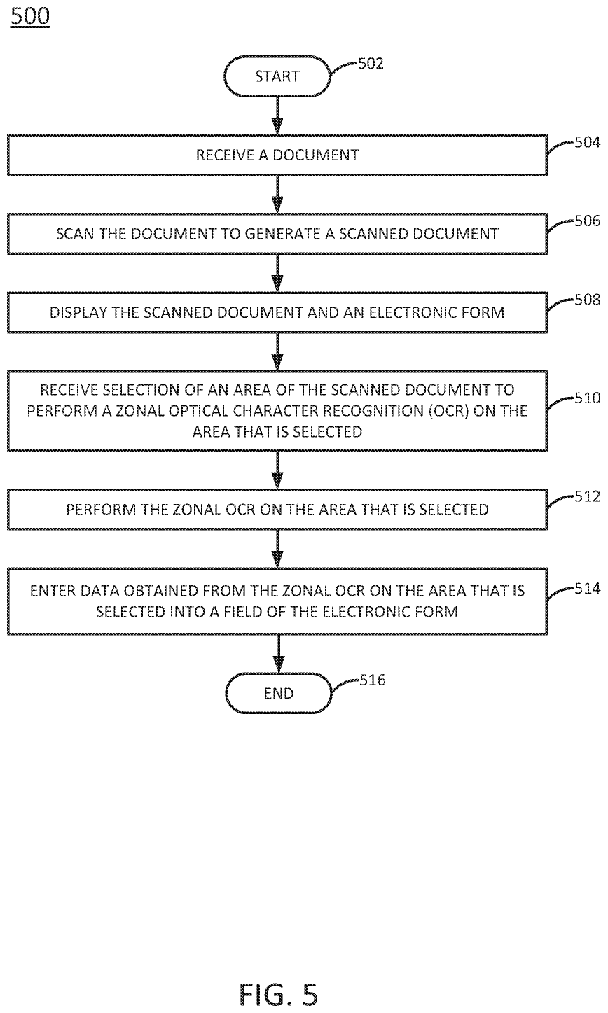

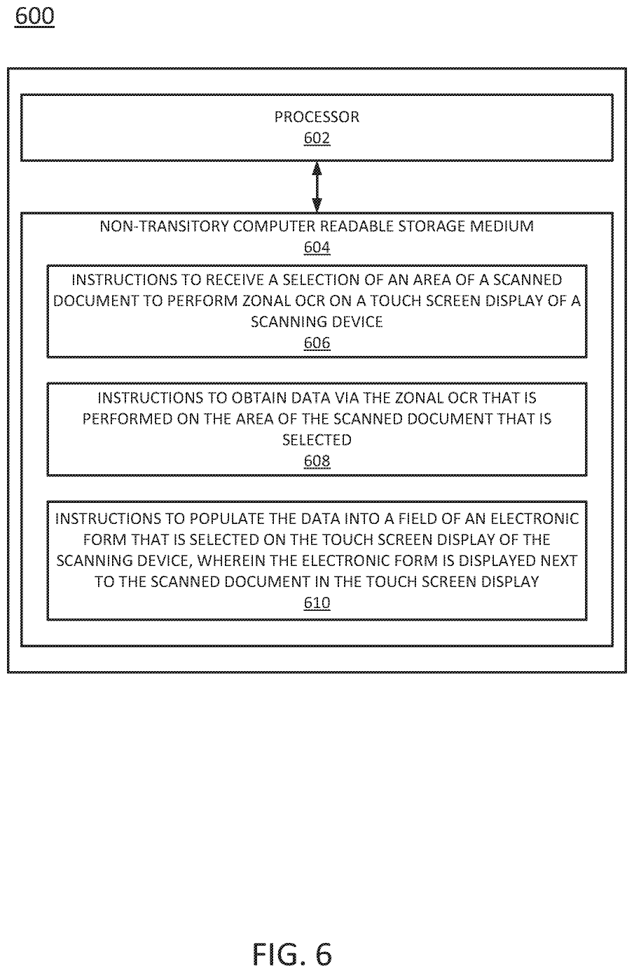

FIG. 5 illustrates a flow diagram of an example method 500 for entering data via zonal OCR selections of a scanned document at a scanning device of the present disclosure. In an example, the method 500 may be performed by the apparatus 100, or the apparatus 600 illustrated in FIG. 6, and described below.

At block 502, the method 500 begins. At block 504, the method 500 receives a document. For example, a user may place a document to be scanned in the scanning device. In one example, the user may also provide a workflow via a graphical user interface (GUI) of the display of the scanning device. The workflow may help the scanning device determine a format of document after it is scanned to automatically populate data into fields of an electronic form, as discussed in further details below.

At block 506, the method 500 scans the document to generate a scanned document. For example, the document may be passed through an imaging component of the scanning device to scan the document and generate the scanned document. The scanned document may be an electronic version or image of the document that is scanned.

At block 508, the method 500 displays the scanned document and an electronic form. In one example, the electronic form may be associated with the workflow. For example, the electronic form may be to generate an invoice, a shipping label, an email, a payroll form, and the like. The scanned document and the electronic form may be shown in the display of the scanning device. For example, the scanned document and the electronic form may be shown side-by-side.

At block 510, the method 500 receives a selection of an area of the scanned document to perform a zonal optical character recognition (OCR) on the area that is selected. For example, the scanning device of the present disclosure may allow a user to complete an electronic form for a workflow at the scanning device.

For example, the display may be a touch screen that provides a GUI. The user may select a field of the electronic document that is displayed and select an area of the scanned document that may include data the user would like to have entered in the field of the electronic form that is selected. At block 512, the method 500 performs the zonal OCR on the area that is selected.

At block 514, the method 500 enters data obtained from the zonal OCR on the area that is selected into a field of the electronic form. For example, a zonal OCR may be performed on the area that is selected. Data obtained from the area that is selected via the zonal OCR may be entered into the field. The field may be automatically selected based on the data that is obtained or may be selected by a user via the GUI. The display and GUI of the scanning device may allow a user to perform ad-hoc data entry of electronic forms with data from scanned documents. As a result, the user does not have to make two trips to complete the electronic form (e.g., one trip to the scanning device and a second trip to the user's workstation or computer). Rather, the entire workflow can be completed at the scanning device in a single trip.

In one example, the scanning device may learn patterns and recognize formats of scanned documents for a particular workflow from the method 500 being repeated by different users for everyday use. The scanning device may then learn the pattern and format and automatically generate a completed electronic form without any formalized training that is performed offline with training data. In other words, the scanning device may “crowd source” the data obtained from everyday use of the scanning device to learn how to automatically populate fields from zonal OCR of known areas of the scanned document.

In one example, a user may place a plurality of different documents into the scanning device and the scanning device may scan each document and have the user select areas for zonal OCR for formats of scanned documents that are unrecognized. However, for scanned documents that have a format that the scanning device recognizes, the scanning device may automatically generate the electronic form.

In one example, a confidence score may be calculated by the scanning device for each electronic form that is completed. For example, the scanning device may predict the areas of the scanned document that may be selected and the associated fields in the electronic form. The confidence score may be based on an accuracy of the predictions made by the scanning device based on other user selections made over everyday use of the scanning device. The confidence score may be a value based on a range (e.g., between 0 to 100) or a percentage (e.g., based on completed fields, identified markers, and the like).

In one example, when a confidence score is above a first confidence threshold (e.g., above 95 percent, 99 percent, and the like) the scanning device may generate a completed electronic form and save the completed electronic form without review. In one example, if the confidence score is within a range between the first confidence threshold and a second confidence threshold (e.g., between 50 percent and 95 percent) the scanning device may try to automatically complete the electronic form with data obtained from the zonal OCR. However, the scanning device may provide the completed or partially completed electronic form in the GUI of the display to allow a user to review the fields that are populated or select areas to perform zonal OCR on the scanned documents to populate the fields that were not completed.

In one example, when the confidence score is below the second confidence threshold (e.g., below 50%) the scanning device may not attempt to complete the electronic form as the format of the scanned document may not be recognize with sufficient confidence. As a result, the scanning device may request the user to perform zonal OCR manually, as described by the method 500, to populate data in the fields for the electronic form. The scanning device may use the manual entry as part of the learning process to learn the format of the scanned document.

In one example, the scanning device may scan and/or analyze certain areas of the scanned document to identify the format of the form. For example, for an invoice workflow, the scanning device may initially check an upper left hand corner to see if address information is detected, or an upper right hand corner to detect a logo, a bottom of the scanned document to look for a company name, and the like.

Based on the analysis of the scanned document, the scanning device may recognize the format of the scanned document. When the format is recognized, the GUI may skip providing fields for a form that is generated for the workflow. Rather, the scanning device may proceed to automatically perform zonal OCR on certain zones based on the format that is recognized.

The zones may be based on the format that is recognized. Each zone may be associated with a field of the form that is to be generated and completed. For example, the scanning device, based on training information obtained over previously scanned documents, may know to scan an upper left hand corner to obtain information for a vendor field based on the recognized format. Then, the scanning device may know where to perform zonal OCR to obtain an invoice number for the invoice number field, and so forth. At block 516, the method 500 ends.

FIG. 6 illustrates an example of an apparatus 600. In an example, the apparatus 600 may be the apparatus 100. In an example, the apparatus 600 may include a processor 602 and a non-transitory computer readable storage medium 604. The non-transitory computer readable storage medium 604 may include instructions 606, 608, and 610 that, when executed by the processor 602, cause the processor 602 to perform various functions.

In an example, the instructions 606 may include instructions to receive a selection of an area of a scanned document to perform zonal OCR on a touch screen display of a scanning device. The instructions 608 may include instructions to obtain data via the zonal OCR that is performed on the area of the scanned document that is selected. The instructions 610 may include instructions to populate the data into a field of an electronic form that is selected on the touch screen display of the scanning device, wherein the electronic form is displayed next to the scanned document in the touch screen display.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
an imaging device to scan a document and generate a scanned document;
a display to provide a graphical user interface (GUI) to display the scanned document and an electronic form;
a zonal optical character recognition (OCR) device to scan a selected area of the scanned document; and
a processor communicatively coupled to the imaging device, the display, and the zonal OCR device, wherein the processor is to receive a selection of the selected area on the display, to receive a selection of a field on the electronic form, to obtain data from the selected area of the scanned document that is scanned, and to enter the data in the field of the electronic form that is selected.

2. The apparatus of claim 1, wherein the display is a touch screen device and the selection of the selected area and the selection of the field are performed via touch input on the display.

3. The apparatus of claim 1, wherein the scanned document and the electronic form are shown side-by-side in the display.

4. The apparatus of claim 1, wherein the processor is to calculate a confidence score based on a prediction of the selected area for the field on the electronic form.

5. The apparatus of claim 4, wherein the prediction is based on data collected from other users that use the apparatus.

6. The apparatus of claim 4, wherein the processor is to automatically populate fields of the electronic form without user selections from data obtained from zonal OCR performed on the scanned document when the confidence score is above a threshold.

7. The apparatus of claim 6, wherein the electronic form that is automatically populated is shown in the display to be verified when the confidence score is below a high threshold and above a low threshold.

8. A method comprising:
receiving, by a processor, a document;
scanning, by the processor, the document to generate a scanned document;
displaying, by the processor, the scanned document and an electronic form;
receiving, by the processor, a selection of an area of the scanned document to perform a zonal optical character recognition (OCR) on the area that is selected;
performing, by the processor, the zonal OCR on the area that is selected; and
entering, by the processor, data obtained from the zonal OCR on the area that is selected into a field of the electronic form.

9. The method of claim 8, wherein the receiving, the performing, and the entering is repeated for a plurality of fields and a plurality of areas on the scanned document.

10. The method of claim 8, further comprising:
receiving, by the processor, an indication of a workflow associated with the document.

11. The method of claim 10, further comprising:
detecting, by the processor, a format associated with the scanned document for the workflow;
calculating, by the processor, a confidence score based on a prediction of the area that is selected and the field that is selected.

12. The method of claim 11, further comprising:
automatically generating, by the processor, a completed electronic form from the data obtained from the scanned document for the workflow when the confidence score is above a high threshold.

13. The method of claim 11, wherein the format is detected based on recognized markers on the scanned document.

14. A non-transitory computer readable storage medium encoded with instructions executable by a processor, the non-transitory computer-readable storage medium comprising:
instructions to receive a selection of an area of a scanned document to perform zonal OCR on a touch screen display of a scanning device;
instructions to obtain data via the zonal OCR that is performed on the area of the scanned document that is selected; and
instructions to populate the data into a field of an electronic form that is selected on the touch screen display of the scanning device, wherein the electronic form is displayed next to the scanned document in the touch screen display.

15. The non-transitory computer readable storage medium of claim 14, further comprising:
instructions to repeat the instructions to receive, the instructions to obtain, and the instructions to populate for a plurality of areas and a plurality of fields until a completed electronic form is generated.
